(19) United States
(12) Patent Application Publication
(10) Pub. No.: US 2009/0139596 A1
(43) Pub. Date: Jun. 4, 2009

(54) DUAL-CONTAINMENT PIPE CONTAINING FLUOROPOLYMER

(75) Inventors: Pierre Kuyl, Orangeburg, NY (US); Yoshihisa Yamamoto, Orangeburg, NY (US)

Correspondence Address: GLOBAL IP COUNSELORS, LLP, 1233 20TH STREET, NW, SUITE 700, WASHINGTON, DC, 20036-2680, US

(73) Assignee: DAIKIN INDUSTRIES, LTD., Osaka-shi, Osaka (JP)

(21) Appl. No.: 12/295,501

(22) PCT Filed: Apr. 11, 2007
(86) PCT No.: PCT/US07/08811

§ 371 Date: Sep. 30, 2008

Related U.S. Application Data
(60) Provisional application No. 60/790,797, filed on Apr. 11, 2006.

(51) Int. Cl. F16L 11/00; F16L 11/20

(52) U.S. Cl. 138/148; 138/104; 138/108; 138/113; 138/114; 138/125; 138/141

(57) ABSTRACT

A dual-containment pipe includes a primary pipe and a secondary pipe having an inner peripheral surface that radially supports an outer peripheral surface of the primary pipe with an interstice formed therebetween. The secondary pipe contains fluoropolymer. The primary pipe has a mono-layered structure of static dissipative fluoropolymer, a multi-layered structure with static dissipative fluoropolymer at its innermost layer, or a multi-layered structure with static dissipative PA at its innermost layer and a fluoropolymer layer.

### BACKGROUND OF THE INVENTION

1. Field of the Invention

The present invention generally relates to dual-containment pipes. More specifically, the present invention relates to a dual-containment pipe containing fluoropolymer, which is designed to be installed underground to transport fluids.

2. Background Information

Pipes have been known to be used to transport fluid (liquid, gas or vapor). For example, such pipes are often disposed underground to transport petroleum-based flammables, combustible liquids, alcohols, or alcohol-blended fuels between gas tanks and dispensers at gasoline retailers. Such pipes are generally subject to various state and federal technical regulations to prevent environmental problems.

Two known types of underground pipes are fiberglass type and flexible type. Flexible type pipes are made of plastic such as PE, nylon (PA), EVOH, and PVDF, and are further divided into rigid type and semi rigid type. Semi rigid type pipes are thinner and more flexible than rigid type pipes. Flexible type pipes are often reinforced with fiberglass, steel wire, or polyester braids. Flexible type pipes are generally more malleable than fiberglass type pipes, and require fewer joints. Thus, flexible type pipes are usually easier to install, while fiber glass type pipes often have better resistance against permeation of the fluid and are often more compatible with petroleum.

One problem with such underground pipes is that they tend to get elongated in the longitudinal direction (swelling) over time. Such swelling can cause the pipes to rupture, which may result in the leakage of the fluid conveyed through the pipe. When such fluid leaks, it is possible for toxic substances contained in the fluid to be emitted in the environment, which is undesirable. Particularly with regard to underground pipes for flammable liquids, due to recent changes in regulations, the maximum amount of swelling allowed over a period of nine months has been reduced to 2% in order to reduce the chances of such swelling and/or leaking occurring.

In view of the above, it will be apparent to those skilled in the art from this disclosure that there exists a need for improved pipes containing fluoropolymer that overcome the problems of the conventional art. This invention addresses this need in the art as well as other needs, which will become apparent to those skilled in the art from this disclosure.

### SUMMARY OF THE INVENTION

One object of the present invention is to provide a dual-containment pipe that allows easy transportation of relatively large volumes of viscous fluids in underground applications.

Another object of the present invention is to provide a dual-containment pipe for underground applications, which minimizes leakage of fluid.

The foregoing objects can basically be attained by providing a dual-containment pipe according to a first aspect of the present invention, which includes a primary pipe constructed of a mono-layered static dissipative fluoropolymer, and a secondary pipe having an inner peripheral surface that is arranged to radially support an outer peripheral surface of the primary pipe with an interstice being formed between the inner peripheral surface of the secondary pipe and the outer peripheral surface of the primary pipe, the secondary pipe containing fluoropolymer.

According to a second aspect of the present invention, in the dual-containment pipe according to the first aspect of the invention, the secondary pipe has a PA-based multi-layered structure.

According to a third aspect of the present invention, in the dual-containment pipe according to the first aspect of the invention, the secondary pipe has a PE-based multi-layered structure.

According to a fourth aspect of the present invention, in the dual-containment pipe according to the first aspect of the invention, the secondary pipe has a mono-layered structure of fluoropolymer.

According to a fifth aspect of the present invention, in the dual-containment pipe according to one of the first through fourth aspects of the invention, the static dissipative fluoropolymer is static dissipative EFEP.

According to a sixth aspect of the present invention, in the dual-containment pipe according to one of the first through fourth aspects of the invention, the static dissipative fluoropolymer is static dissipative ETFE.

A dual-containment pipe according to a seventh aspect of the present invention includes a multi-layered primary pipe having an innermost layer constructed of a static dissipative fluoropolymer, and a secondary pipe having an inner peripheral surface that is arranged to radially support an outer peripheral surface of the primary pipe with an interstice being formed between the inner peripheral surface of the secondary pipe and the outer peripheral surface of the primary pipe, the secondary pipe containing fluoropolymer.

According to an eighth aspect of the present invention, in the dual-containment pipe according to the seventh aspect of the invention, the primary pipe has a PA-based multi-layered structure.

According to a ninth aspect of the present invention, in the dual-containment pipe according to the seventh aspect of the invention, the primary pipe has a PE-based multi-layered structure.

According to a tenth aspect of the present invention, in the dual-containment pipe according to one of the seventh through ninth aspects of the invention, the secondary pipe has a PA-based multi-layered structure.

According to an eleventh aspect of the present invention, in the dual-containment pipe according to one of the seventh through ninth aspects of the invention, the secondary pipe has a PE-based multi-layered structure.

According to a twelfth aspect of the present invention, in the dual-containment pipe according to one of the seventh through ninth aspects of the invention, the secondary pipe has a mono-layered structure of fluoropolymer.

According to a thirteenth aspect of the present invention, in the dual-containment pipe according to one of the seventh through twelfth aspects of the invention, the static dissipative fluoropolymer is static dissipative EFEP.

According to a fourteenth aspect of the present invention, in the dual-containment pipe according to one of the seventh through twelfth aspects of the invention, the static dissipative fluoropolymer is static dissipative ETFE.

A dual-containment pipe according to a fifteenth aspect of the present invention includes a multi-layered primary pipe having an innermost layer constructed of a static dissipative PA and a fluoropolymer layer, and a secondary pipe having an inner peripheral surface that is arranged to radially support an outer peripheral surface of the primary pipe with an interstice being formed between the inner peripheral surface of the secondary pipe and the outer peripheral surface of the primary pipe, the secondary pipe containing fluoropolymer.

According to a sixteenth aspect of the present invention, in the dual-containment pipe according to the fifteenth aspect of the invention, the primary pipe has a PA-based multi-layered structure.

According to a seventeenth aspect of the present invention, in the dual-containment pipe according to the fifteenth aspect of the invention, the primary pipe has a PE-based multi-layered structure.

According to an eighteenth aspect of the present invention, in the dual-containment pipe according to one of the fifteenth through seventeenth aspects of the invention, the secondary pipe has a PE-based multi-layered structure.

According to a nineteenth aspect of the present invention, in the dual-containment pipe according to one of the fifteenth through seventeenth aspects of the invention, the secondary pipe has a mono-layered structure of fluoropolymer.

In accordance with another aspect of the present invention, in the dual-containment pipes according to any of the above aspects, the primary pipe has an internal cross-sectional shape defining a flow area of at least 450 mm².

In accordance with another aspect of the present invention, in the dual-containment pipes according to any of the above aspects, a leak detection sensor is disposed in the interstice between the inner peripheral surface of the secondary pipe and the outer peripheral surface of the primary pipe.

In accordance with another aspect of the present invention, in the dual-containment pipes according to any of the above aspects, the dual containment pipe is substantially rigid and substantially inelastic.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a partial side elevational view (on a reduce scale) of a dual containment pipe in accordance with the present invention; and

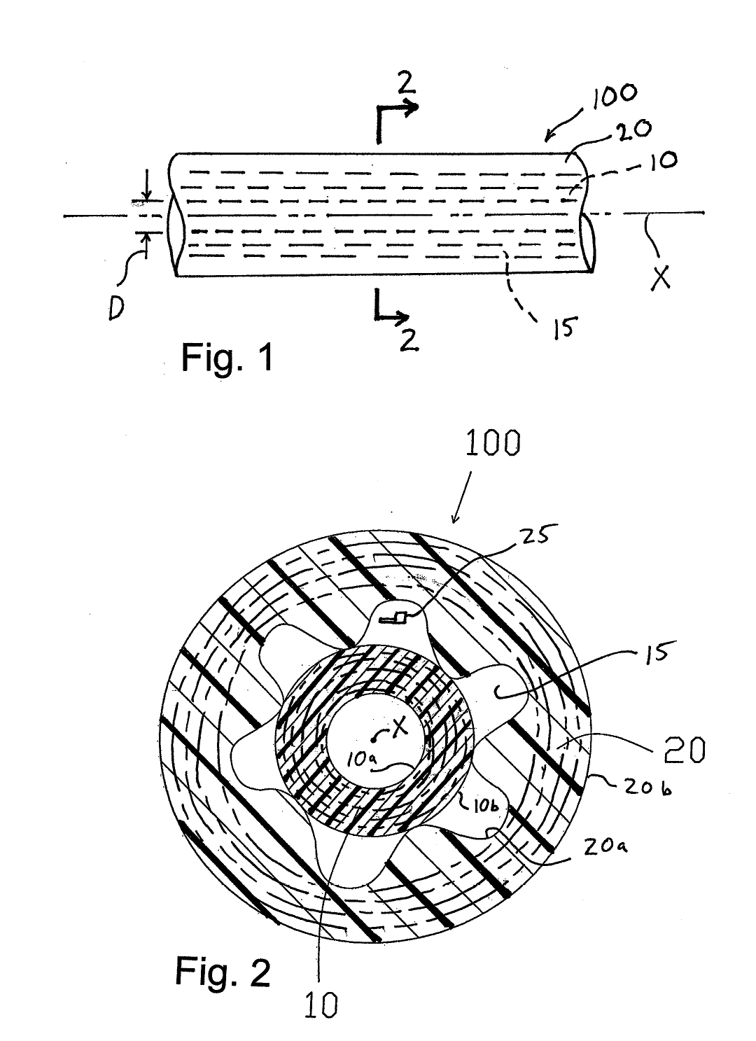

Figure is a schematic, cross-sectional view of a dual-containment pipe illustrated in FIG. 1, as seen along section line 2-2 of FIG. 1 in accordance with the present invention.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

Referring to FIGS. 1 and 2, a dual-containment pipe 100 is illustrated in accordance with the present invention. The dual-containment pipe 100 is designed to transport flammable and/or volatile liquids such as petroleum-based fuel (gasoline, diesels, biodiesels, Fuel C), alcohol blended fuels (CE-10, CM-15, CE-30, CM-50, CE-50, CM-85, CE-85), pure alcohols (ethanol, methanol), toluene, acids and bases. The dual-containment pipe 100 has a dual containment structure, with an inner supply pipe (primary pipe) 10 and an outer containment pipe (secondary pipe) 20. The inner supply pipe (primary pipe) 10 can be mono-layered or multi-layered in accordance with the present invention, as explained below. Similarly, the outer containment pipe (secondary pipe) 20 can be mono-layered or multi-layered, as explained below.

The secondary pipe 20 is provided around the outer periphery of the primary pipe 10 to radially support the primary pipe 10, yet to form a fluid containment interstice or gap 15 between the primary pipe 10 and the secondary pipe 20. A leak detection sensor (e.g. a pressure sensor) 25 is disposed within the interstice 15 to detect any leakage of liquid from within the primary pipe 10 into the interstice 15. The primary pipe 10 has an internal surface 10a, which conveys the fluid, and an outer surface 10b which is supported by the secondary pipe 20. The secondary pipe 20 has a corrugated internal surface 20a, which supports the outer surface 10b, and an external surface 20b.

Preferably, the primary pipe 10 and the secondary pipe 20 have substantially cylindrical shapes surrounding a longitudinal center axis X, which defines the axial direction of the dual containment pipe 100. The radial direction should be interpreted relative to the axis X. The corrugated internal surface 20a of the secondary pipe 20 can have a spiral configuration or parallel channel configuration. In other words, the internal surface 20a of the secondary pipe 20 can have a uniform shape along the entire axial length of the dual containment pipe 100, or have a spiral configuration. In any case, the internal surface 20b preferably has a minimum internal diameter substantially equal to an outer diameter of the primary pipe 10 and a maximum internal diameter larger than the minimum diameter.

In the dual-containment pipe 100, the inner peripheral surface 20a of the secondary pipe 20 is corrugated, such that the primary pipe 10 can be prevented from moving radially within the secondary pipe 20 and stably positioned therein, yet the gap or interstice 15 can be provided in order to potentially receive any leaking fluid. It will be apparent to those skilled in the art from this disclosure that the dual-containment pipe 100 can have primary and secondary pipes that are both corrugated. Furthermore, it will be apparent to those skilled in the art from this disclosure that the other structures are possible in order to radially support the primary pipe within the secondary pipe and provide an interstice or gap. For example, if neither of the primary and secondary pipes is corrugated, the secondary pipe could have internally extending studs spaced axially and circumferentially across the circumference of its inner peripheral surface, such that the primary pipe can be prevented from moving radially within the secondary pipe. In other words, at least one of the inner peripheral surface 20a and the outer peripheral surface 10b preferably includes a plurality of radially extending projections such that the primary pipe 10 can be prevented from moving radially within the secondary pipe 20 and stably positioned therein, yet the gap or interstice 15 can be provided in order to potentially receive any leaking fluid. When at least some flexibility is desired of a dual-containment pipe, a corrugated layer is often provided, since such a corrugated layer augments the flexibility of the dual-containment pipe. However, the dual containment pipe 100 of the present invention is substantially rigid and substantially inelastic. In other words, the dual containment pipe 100 has very limited flexibility. Specifically, because the dual containment pipe 100 is designed to be buried underground, it is desirable that the dual containment pipe 100 is substantially rigid so that the earth surrounding the dual containment pipe 100 can be supported without the dual containment pipe 100 collapsing. However, the dual containment pipe 100 can be deformed slightly (i.e. the dual containment pipe 100 is slightly malleable) due to the corrugated layer in order to assist in installing the dual containment pipe 100 underground.

Due to the above arrangement, when using the dual-containment pipe 100, a plurality of dual-containment pipes 100 are typically connected to one another by being inserted into tubular fittings. The dual-containment pipes 100 are coupled to the fittings by attaching the outer peripheral surfaces of the secondary pipes to the inner peripheries of the fittings by electrofusion or with mechanical camps.

As mentioned above, the dual containment pipe 100 is designed to be buried underground in order to convey volatile fluids underground. Preferably, the primary pipe 10 has an inner diameter D that is at least 25 millimeters. In one example, the inner diameter D is about 50-60 millimeters. However, it will be apparent to those skilled in the art from this disclosure that the inner diameter D can be larger (e.g., 100 millimeters, 200 millimeters, 300 millimeters, or even larger) if needed and/or desired. The pipes 10 and 20 preferably have circular shapes. Thus, the primary pipe 10 has an internal cross-sectional shape defining a flow area (cross-sectional area) of at least 450 mm² based on a radius of about 12 millimeters. More specifically, the example having the primary pipe 10 having a circular internal diameter of 50-60 millimeters has an internal cross-sectional flow area between about 1950 mm² and about 2800 mm². Larger inner diameter primary pipes will have a corresponding larger flow area depending on the inner diameter. In the example of the primary pipe 10 having an inner diameter D of 50-60 millimeters mentioned above, each of the pipes 10 and 20 preferably has a radial thickness of about 3.0 millimeters (i.e. about 5-6% of the inner diameter D). Such dimensional relationships can be applied to smaller/larger pipes. In any case, each of the pipes 10 and 20 preferably has a radial thickness less than 20% of the inner diameter D (preferably less than 10% of the inner diameter D). In other words, the thickness of the pipes 10 and 20 and the thickness of the gap 15 as compared to the inner diameter D in the drawings are exaggerated for the purpose of illustration.

In one embodiment of the present invention, the primary pipe 10 has a multi-layered structure. More specifically, the primary pipe 10 of this embodiment of the present embodiment preferably has, from the inner peripheral side, a static dissipative fluoropolymer innermost layer/a fluoropolymer layer/a polyamide (nylon or PA) layer/a polyethylene (PE) layer/another PA layer/and another fluoropolymer layer. In FIG. 1, these layers are only diagrammatically illustrated with phantom lines. However, the exact number and thickness of layers are not necessarily illustrated due to the variety of possible configurations of layers for the primary pipe 10, as explained in further detail below.

The fluoropolymers in this application refer to polymers which include in its main chain a fluoro-containing monomer unit contributed by a fluoro-containing monomer. The fluoropolymers can also contain a non-fluoro-containing monomer unit contributed by a non-fluoro-containing monomer. The “monomer unit” in this application means a part of the polymer molecular structure that is contributed by a monomer. For instance, the tetrafluoroethylene unit is expressed as —CF₂—CF₂—.

The fluoro-containing monomers can be any chemical substances that contain fluorine and are capable of copolymerization. Examples of such fluoro-containing monomers include tetrafluoroethylene (TFE), vinylidene difluoride (VdF), chlorotrifluoroethylene (CTFE), vinyl fluoride (VF), hexafluoropropylene (HFP), hexafluoroisobutene, perfluoro(alkylvinylether) (PAVE), and monomers that are expressed as the following formula (i)

CH₂═CX1-(CF₂)n-X2 (i)

where X1 is either a hydrogen atom or a fluorine atom, X2 is a hydrogen atom, a fluorine atom, or a chlorine atom, and n is a natural number of 1-10.

The non-fluoro-containing monomers can be any chemical substances that do not contain a fluorine atom and are capable of copolymerization. Examples of such non-fluoro-containing monomers include ethylene (Et), propylene, 1-butene, 2-butene, chloroethylene, and vinylidene chloride.

Examples of the fluoropolymer include following copolymers (I) and (II).

(I) copolymer obtained by copolymerization of at least tetrafluoroethylene and ethylene.

(II) copolymer obtained by copolymerization of tetrafluoroethylene and at least one monomer that is expressed in the following formula (ii)

CF₂═CF-Rf2 (ii)

where Rf2 is either —CF₃ or —O-Rf1, Rf1 being a perfluoroalkyl group with carbon number 1-5.

An example of the above described copolymer (I) is a copolymer having 20-80 mol % of tetrafluoroethylene units and 80-20 mol % of ethylene units. The mol % is obtained based on the 19-F NMR (nuclear magnetic resonance) chart.

The main chain of the copolymer (I) can include, other than the tetrafluoroethylene unit and the ethylene unit, additional monomer units that are contributed by other monomers capable of copolymerization. The copolymer (I) can include one type or more than one types of such additional monomers. The type of such monomers to be added is selected to adjust the property of the resulting copolymer. Examples of such additional monomers include hexafluoropropylene, trichlorofluoroethylene, propylene, and monomers expressed as the following formulae (iii) and (iv):

CX3₂=CX4-(CF₂)n-X5 (iii)

CF₂═CF—O-Rf1 (iv)

where X3 is either a hydrogen atom or a fluorine atom, X4 is either a hydrogen atom or a fluorine atom, with X3 and X4 being either the same or different, X5 is a hydrogen atom, a fluorine atom, or a chlorine atom, and n is a natural number of 1-10, and where Rf1 is a perfluoroalkyl group with carbon number 1-5.

The additional monomer units may constitute 0-20 mol % of all the monomer units that form the molecular chain of the copolymer (I).

As the fluoropolymer, the copolymer (I) is preferable due to its high resistivity against heat and chemicals, high weather tolerance, high capacity for electrical insulation, low chemical permeation rate, and its non-adhesiveness. TFE/HFP/Et copolymer is particularly preferable due to its high resistivity against heat and chemicals, high weather tolerance, high capacity for electrical insulation, low chemical permeation rate, non-adhesiveness, and its processability at low temperature. TFE/HFP/Et copolymer should contain preferably 5-20 mol %, more preferably 8-17 mol %, of HFP units. Such TFE/HFP/Et copolymer can contain, in addition to the monomer units that are contributed by TFE, HFP and Et, one type or more than one types of the above-described additional monomers other than HFP, as long as the preferable properties of the resulting TFE/HFP/Et copolymer are unaffected.

In other words, the fluoropolymer can be any of TFE/HEP (FEP), TFE/PAVE (PFA), TFE/Et (ETFE), TFE/HFP/Et (EFEP) and CTFE (PCTFE), which are commercially available from Daikin America, Inc. (Orangeburg, N.Y.). The fluoropolymer layer that directly attaches to either of the PA layers is a reactive fluoropolymer, which is either ETFE or EFEP. The static dissipative fluoropolymer is, for example, a static dissipative EFEP, such as one commercially sold by Daikin America, Inc. (Orangeburg, N.Y.) under the product name RP-5000AS, or static dissipative PFA.

As discussed above, the inner peripheral surface of the primary pipe 10, which is the surface that contacts the liquid, is statically dissipative. More specifically, the inner peripheral surface of the static dissipative fluoropolymer is formed such that its surface resistivity (ρs) is 1×10¹² Ω/sq or less, preferably 1×10⁶ Ω/sq (i.e., 1 M Ω/sq) or less. Surface resistivity (ρs) is determined using ASTM D257 measuring method. Since the inner peripheral surface of the primary pipe 10 is rendered conductive, it is easier to transport viscous liquid at a high speed without being affected by a static discharge.

The secondary pipe 20 of this embodiment is also multi-layered, with ETFE and EFEP, for example. As described above, an inner peripheral surface of the secondary pipe 20 radially supports an outer peripheral surface of the primary pipe 10, creating the interstice 15 therebetween. ETFE and EFEP are preferable as the fluoropolymer of the secondary pipe 20 due to their mechanical superiority.

Although both the primary pipe 10 and the secondary pipe 20 have multi-layered structures in the above described embodiment, either or both of the primary pipe 10 and the secondary pipe 20 may be mono-layered. In FIG. 1, layers are only diagrammatically illustrated with phantom lines due to this possibility.

When the primary pipe 10 is mono-layered, it should be constructed of a static dissipative fluoropolymer. Such mono-layered primary pipe 10 can be made in a corrugated manner if desired, or having a smooth outer shape as illustrated herein. The primary pipe 10 can also be dual-layered, with a static dissipative fluoropolymer as an inner layer and another fluoropolymer as an outer layer.

The primary pipe 10 can also have a PA-based multi-layered structure. Examples of PA-based multi-layered structures of the primary pipe 10 include, from the inner peripheral side to the outer peripheral side: (1) static dissipative fluoropolymer/fluoropolymer/PA/fluoropolymer; (2) static dissipative fluoropolymer/fluoropolymer/PA/fluoropolymer/another fluoropolymer; (3) static dissipative PA/PA/fluoropolymer/PA; and (4) static dissipative fluoropolymer/adhesive/PE/adhesive/fluoropolymer, where “PA” includes PA6, 66, 610, 612, 11, 12, and “PE” includes polyethylene (HDPE, MDPE, LDPE), modified polyethylene such as epoxy modified polyethylene and maleic acid modified polyethylene. Examples of the adhesive include ethylene-vinyl alcohol (EVOH). The fluoropolymer can be any of FEP, PFA, ETFE, EFEP, and CTFE. FEP has superior flexibility and barrier properties, and accordingly is suited as the fluoropolymer for the primary pipe 10. Also, reactive fluoropolymer, which is ETFE and EFEP, can chemically bond to a wide range of materials such as, but not limited to, nylons, EVOH, PE, metals and glass. As shown by the above examples, preferably, adhesive is not required (except example (4) above) to bond the various layers together.

Furthermore, the primary pipe 10 can additionally have one or more layers of other thermoplastics such as nylon (PA6, 66, 610, 612, 11, 12) and polyethylene (HDPE, MDPE, LDPE), modified polyethylene, polypropylene, EVOH, poly(p-phenylene sulfide) (PPS), polybutylene terephthalate (PBT), or thermoset resins such as glass fiber reinforced epoxy resins.

Unlike the primary pipe 10, the secondary pipe 20 is not required to include static dissipative fluoropolymer. However, the secondary pipe 20 preferably contains fluoropolymer. The secondary pipe 20 may also have a mono-layered structure or a multi-layered structure. Examples of the structure of the secondary pipe 20 include, from the inner peripheral side to the outer peripheral side: (1) fluoropolymer mono layer; (2) fluoropolymer/PA/fluoropolymer; (3) static dissipative fluoropolymer/fluoropolymer/PA/fluoropolymer; (4) fluoropolymer/PA/fluoropolymer/another fluoropolymer; (5) static dissipative fluoropolymer/fluoropolymer/PA/fluoropolymer/another fluoropolymer; PA/fluoropolymer/PA; (6) static dissipative PA/PA/fluoropolymer/PA; (7) fluoropolymer/PA/PE/PA/fluoropolymer; (8) static dissipative fluoropolymer/fluoropolymer/PA/PE/PA/fluoropolymer; and (9) fluoropolymer/adhesive/PE/adhesive/fluoropolymer. Examples of the adhesive include EVOH. Any of these examples can be used with the primary pipe configurations described above.

Furthermore, the secondary pipe 20 can additionally have one or more layers of other thermoplastics such as nylon (PA6, 66, 610, 612, 11, 12), and PE (HDPE, MDPE, LDPE), modified polyethylene, polypropylene, EVOH, PPS, PBT, or thermoset resins such as glass fiber reinforced epoxy and polyester resin.

Generally, mono-layered fluoropolymer pipes have better performance than multi-layered ones, although mono-layered fluoropolymer pipes tend to be more costly. Among multi-layered fluoropolymer pipes, PA-based ones tend to perform better than PE-based ones since PE-based multi-layered fluoropolymer pipes generally have greater swelling problems, although PA-based ones are more expensive. The dual-containment pipe 100 of the present invention can have a combination of a primary pipe having any of the structures described above and a secondary pipe having any of the structures described above.

Furthermore, either or both of the primary and secondary pipes can be reinforced with fiberglass, steel wire, or polyester braids, regardless of whether they are mono-layered or multi-layered.

The dual-containment pipe 100 described above can be manufactured either by co-extrusion, or by separately extruding the primary and secondary pipes. Preferably, the primary pipe 10 is constructed by co-extrusion, and the secondary pipe is constructed separately by co-extrusion. After constructing the primary pipe 10 and the secondary pipe 20, the primary pipe 10 is preferably slid into the secondary pipe 20. Particularly, when the primary and secondary pipes 10 and 20 are made of thermoplastic resins whose melting points are significantly different, the dual-containment pipe should be manufactured by separate extrusions of the primary and secondary pipes. For instance, when the primary pipe is made of a high melting point fluoropolymer such as FEP and the secondary pipe is made of a low melting point fluoropolymer such as EFEP, the dual containment pipe should be manufactured by separate extrusions of the primary and secondary pipes. The clearances between the primary pipe 10 and the secondary pipe 20 are preferably such that the various channels of the corrugated interstice or gap 15 communicate with each other. Thus, the leak detection sensor 25 can detect a fluid leak into any channel of the corrugated gap 15.

The dual-containment pipe of the present invention contains fluoropolymer, which generally has very small swelling and weight gain when immersed in flammable fluids. Furthermore, fluoropolymer has superior permeation resistance to alcohol. Thus, distortion of pipes can be reduced. Accordingly, leaks of the fluids into the environment can also be reduced. Furthermore, fluoropolymer has superior chemical resistance, and therefore can be compatible with various fluids to be transported.

When reactive fluoropolymer is utilized in the dual-containment pipe with multi-layered primary or secondary pipe, such reactive fluoropolymer has a superior ability to chemically bond to other materials. In other words, use of adhesives between layers can generally be avoided with the present invention, except for one example above. Thus, delamination of the fluoropolymer layer is unlikely to occur, even when the dual-containment pipe has a corrugated structure.

Since the pipe of the present invention has a static dissipative inner peripheral surface, viscous fluid can be transported through the pipe at a high speed easier. Particularly, flammable fluid can be transported without being affected by static discharge.

As used herein, the following directional terms “forward, rearward, above, downward, vertical, horizontal, below and transverse” as well as any other similar directional terms refer to those directions of a device equipped with the present invention. Accordingly, these terms, as utilized to describe the present invention should be interpreted relative to a device equipped with the present invention.

The term “configured” as used herein to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

The terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A dual-containment pipe adapted to be installed underground to transport fluid, comprising:
a primary pipe constructed of a mono-layered static dissipative fluoropolymer; and
a secondary pipe having an inner peripheral surface that is arranged to radially support an outer peripheral surface of the primary pipe with an interstice being formed between the inner peripheral surface of the secondary pipe and the outer peripheral surface of the primary pipe, the secondary pipe containing fluoropolymer.

2. The dual-containment pipe according to claim 1, wherein
the secondary pipe has a PA-based multi-layered structure.

3. The dual-containment pipe according to claim 1, wherein
the secondary pipe has a PE-based multi-layered structure.

4. The dual-containment pipe according to claim 1, wherein
the secondary pipe has a mono-layered structure of fluoropolymer.

5. The dual-containment pipe according to claim 1, wherein
the static dissipative fluoropolymer is static dissipative EFEP.

6. The dual-containment pipe according to claim 1, wherein
the static dissipative fluoropolymer is static dissipative ETFE.

7. A dual-containment pipe adapted to be installed underground to transport fluid, comprising:
a multi-layered primary pipe having an innermost layer constructed of a static dissipative fluoropolymer; and
a secondary pipe having an inner peripheral surface that is arranged to radially support an outer peripheral surface of the primary pipe with an interstice being formed between the inner peripheral surface of the secondary pipe and the outer peripheral surface of the primary pipe, the secondary pipe containing fluoropolymer.

8. The dual-containment pipe according to claim 7, wherein
the primary pipe has a PA-based multi-layered structure.

9. The dual-containment pipe according to claim 7, wherein
the primary pipe has a PE-based multi-layered structure.

10. The dual-containment pipe according to claim 7, wherein
the secondary pipe has a PA-based multi-layered structure.

11. The dual-containment pipe according to claim 7, wherein
the secondary pipe has a PE-based multi-layered structure.

12. The dual-containment pipe according to claim 7, wherein
the secondary pipe has a mono-layered structure of fluoropolymer.

13. The dual-containment pipe according to claim 7, wherein
the static dissipative fluoropolymer is static dissipative EFEP.

14. The dual-containment pipe according to claim 7, wherein
the static dissipative fluoropolymer is static dissipative ETFE.

15. A dual-containment pipe adapted to be installed underground to transport fluid, comprising:
a multi-layered primary pipe having an innermost layer constructed of a static dissipative PA and a fluoropolymer layer; and
a secondary pipe having an inner peripheral surface that is arranged to radially support an outer peripheral surface of the primary pipe with an interstice being formed between the inner peripheral surface of the secondary pipe and the outer peripheral surface of the primary pipe, the secondary pipe containing fluoropolymer.

16. The dual-containment pipe according to claim 15, wherein
the primary pipe has a PA-based multi-layered structure.

17. The dual-containment pipe according to claim 15, wherein
the primary pipe has a PE-based multi-layered structure.

18. The dual-containment pipe according to claim 15, wherein
the secondary pipe has a PE-based multi-layered structure.

19. The dual-containment pipe according to claim 15, wherein
the secondary pipe has a mono-layered structure of fluoropolymer.

20. The dual-containment pipe according to claim 15, wherein
the primary pipe has an internal cross-sectional shape defining a flow area of at least 450 mm².

21. The dual-containment pipe according to claim 15, further comprising
a leak detection sensor disposed in the interstice between the inner peripheral surface of the secondary pipe and the outer peripheral surface of the primary pipe.

22. The dual-containment pipe according to claim 15, wherein
the dual containment pipe is substantially rigid and substantially inelastic.

23. The dual-containment pipe according to claim 1, wherein
the primary pipe has an internal cross-sectional shape defining a flow area of at least 450 mm².

24. The dual-containment pipe according to claim 1, further comprising
a leak detection sensor disposed in the interstice between the inner peripheral surface of the secondary pipe and the outer peripheral surface of the primary pipe.

25. The dual-containment pipe according to claim 1, wherein
the dual containment pipe is substantially rigid and substantially inelastic.

26. The dual-containment pipe according to claim 7, wherein
the primary pipe has an internal cross-sectional shape defining a flow area of at least 450 mm².

27. The dual-containment pipe according to claim 7, further comprising
a leak detection sensor disposed in the interstice between the inner peripheral surface of the secondary pipe and the outer peripheral surface of the primary pipe.

28. The dual-containment pipe according to claim 7, wherein
the dual containment pipe is substantially rigid and substantially inelastic.
